(19) United States
(12) Patent Application Publication
(10) Pub. No.: US 2015/0113731 A1
(43) Pub. Date: Apr. 30, 2015

(54) FLOOR-STRETCHING EXERCISE MAT WITH MOVEMENT GUIDING FUNCTION AND A MOVEMENT GUIDING METHOD

(71) Applicant: Hong-Mao LIU, Taichung City (TW)

(72) Inventor: Hong-Mao LIU, Taichung City (TW)

(21) Appl. No.: 14/065,112

(22) Filed: Oct. 28, 2013

(51) Int. Cl. F21V 23/00; F21V 33/00; F21V 23/04; A63B 21/00

(52) U.S. Cl. CPC F21V 23/003; A63B 21/1473; F21V 33/008; F21V 23/04
USPC 5/417

(57) ABSTRACT

A floor-stretching exercise mat with movement guiding function and a movement guiding method is designed to reduce sports injury and provided with: a guiding mat, a control unit and a transparent buffering mat. The guiding mat includes a guiding board and a plurality of light generating elements disposed on the guiding board and at least one guiding portion capable of continuously displaying predetermined shapes in different positions, the light generating elements constitute the guiding portion. The control unit is electrically connected to the guiding mat to control the shapes and positions of the guiding portions, and the transparent buffering mat is placed on the guiding mat.

### BACKGROUND OF THE INVENTION

1. Field of the Invention

The present invention relates to a floor-stretching exercise mat, and more particularly to a floor-stretching exercise mat with movement guiding function.

2. Description of the Prior Art

In order to reduce impact and enhance comfortableness during yoga or Pilates exercise, people usually put an elastic mat 10 on the floor and do exercise on the mat 10.

However, this mat 10 only can absorb impact but does not have the movement guiding function. Therefore, the user (the people doing exercises, such as Yoga, Pilates . . . ) has to remember every movement when practicing yoga or Pilates, otherwise, he/she won't be able to finish the whole course of Yoga or Pilates, and also incorrect movements or body positions may cause harm to the user.

Besides, incorrect body positions would have a bad influence on the stretching exercise effect when the user is doing floor stretching exercise on the mat, especially, when there is no teacher around.

To improve the effect of floor stretching exercise, the user has to do Yoga or Pilates in a particular classroom where there is a teacher teaching the user to practice exercise, which is likely encourage the user's laziness and dependency on the teacher, especially, when the weather is uncomfortable, the user is very likely to cancel the floor stretching exercise.

The present invention has arisen to mitigate and/or obviate the afore-described disadvantages.

### SUMMARY OF THE INVENTION

The primary objective of the present invention is to provide a floor-stretching exercise mat with movement guiding function and a movement guiding method to reduce sports injury.

To achieve the above objective, a floor-stretching exercise mat with movement guiding function in accordance with the present invention, comprises: a guiding mat including guiding board and a plurality of light generating elements disposed on the guiding board and at least one guiding portion capable of continuously displaying predetermined shapes in different positions, the light generating elements constituting the guiding portion; a control unit electrically connected to the guiding mat to control the shapes and positions of the guiding portions; and a transparent buffering mat placed on the guiding mat.

Preferably, the floor-stretching exercise mat with movement guiding function further comprises a transparent sensing mat which is disposed between the guiding mat and the buffering mat and includes a sensor aligned with the light generating elements of the guiding mat.

Preferably, the control unit includes a switch control button, an acoustic button, a mode button, a program button, a display, and a wire or wireless receiver/transmitter for receiving or transmitting signal.

Preferably, the display displays a standard movement icon corresponding to the guiding portions.

Preferably, the floor-stretching exercise mat with movement guiding function further comprises a camera capable of catching and uploading body position/posture of a user to the internet.

A floor-stretching exercise mat with movement guiding function in accordance with another embodiment of the present invention comprises: a guiding mat including guiding board and a plurality of light generating elements disposed on the guiding board and at least one guiding portion capable of continuously displaying predetermined shapes in different positions, the light generating elements constituting the guiding portion; a control unit electrically connected to the guiding mat to control the shapes and positions of the guiding portions; and a buffering mat placed on the guiding mat and including a plurality of light-passing apertures aligned with the light generating elements.

Preferably, the floor-stretching exercise mat with movement guiding function further comprises a transparent sensing mat which is disposed between the guiding mat and the buffering mat and includes a sensor aligned with the light generating elements of the guiding mat.

Preferably, the control unit includes a switch control button, an acoustic button, a mode button, a program button, a display, and a wire or wireless receiver/transmitter for receiving or transmitting signal.

Preferably, the display displays a standard movement icon corresponding to the guiding portions.

Preferably, the floor-stretching exercise mat with movement guiding function further comprises a camera capable of catching and uploading body position/posture of a user to the internet.

A movement guiding method for guiding exercise movement by using a floor-stretching exercise mat which comprises the guiding mat, the control unit and the transparent buffering mat, the movement guiding method comprises the following steps:

operating the control unit to make the guiding mat continuously display guiding portions of predetermined shapes at predetermined positions; and

a user practicing exercise based on the shapes and positions of the guiding portions.

### BRIEF DESCRIPTION OF THE DRAWINGS

FIG. 1 is a perspective view of a conventional buffering mat;

FIG. 2 is an exploded view of a floor-stretching exercise mat with movement guiding function in accordance with a first embodiment of the present invention;

FIG. 3 is an assembly view of the floor-stretching exercise mat with movement guiding function in accordance with the first embodiment of the present invention;

FIG. 4 is a side view of a part of the floor-stretching exercise mat in accordance with the first embodiment of the present invention;

FIG. 5A is a top view of the floor-stretching exercise mat in accordance with the first embodiment of the present invention, showing that there is only a single guiding portion displayed on the guiding mat;

FIG. 5B is a side view showing that a user is doing exercise based on the guiding portion shown in FIG. 5A;

FIG. 6A is a top view of the floor-stretching exercise mat in accordance with the first embodiment of the present invention, showing that there are four guiding portions of different shapes displayed on the guiding mat;

FIG. 6B is a side view showing that a user is doing exercise based on the guiding portion shown in FIG. 6A;

FIG. 7A is a top view of the floor-stretching exercise mat in accordance with the first embodiment of the present invention, showing that there is only a single guiding portion displayed on the guiding mat;

FIG. 7B is a side view showing that a user is doing exercise based on the guiding portion shown in FIG. 7A;

FIG. 8 is an exploded view of a floor-stretching exercise mat with movement guiding function in accordance with a second embodiment of the present invention;

FIG. 9 is a side view of the floor-stretching exercise mat with movement guiding function in accordance with the second embodiment of the present invention;

FIG. 10 is an exploded view of a floor-stretching exercise mat with movement guiding function in accordance with a third embodiment of the present invention;

FIG. 11 is a side view of the floor-stretching exercise mat with movement guiding function in accordance with the third embodiment of the present invention;

FIG. 12 is a side view of the floor-stretching exercise mat with movement guiding function in accordance with a fourth embodiment of the present invention;

FIG. 13A is a top view of the floor-stretching exercise mat with movement guiding function in accordance with a fifth embodiment of the present invention;

FIG. 13B is a side view of the floor-stretching exercise mat with movement guiding function in accordance with the fifth embodiment of the present invention.

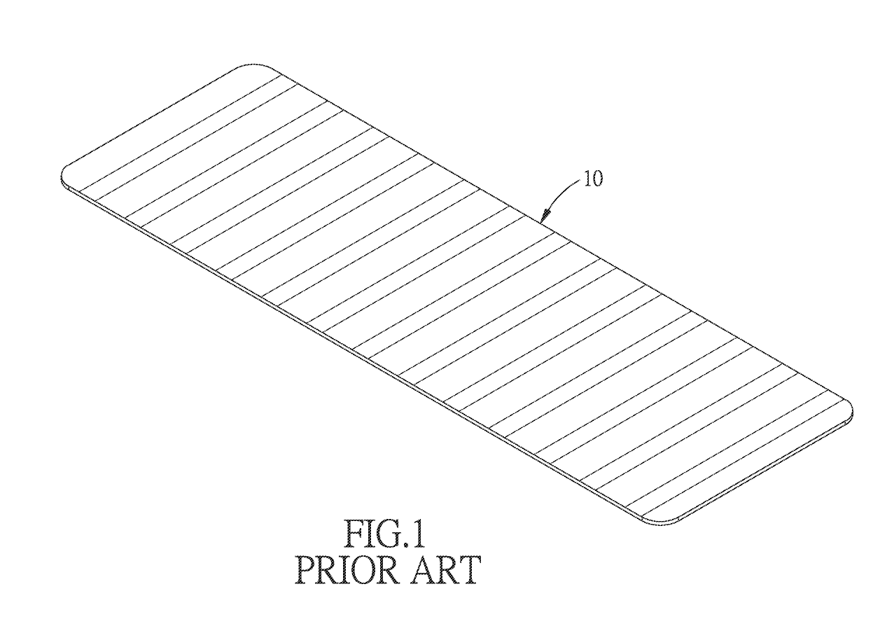

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

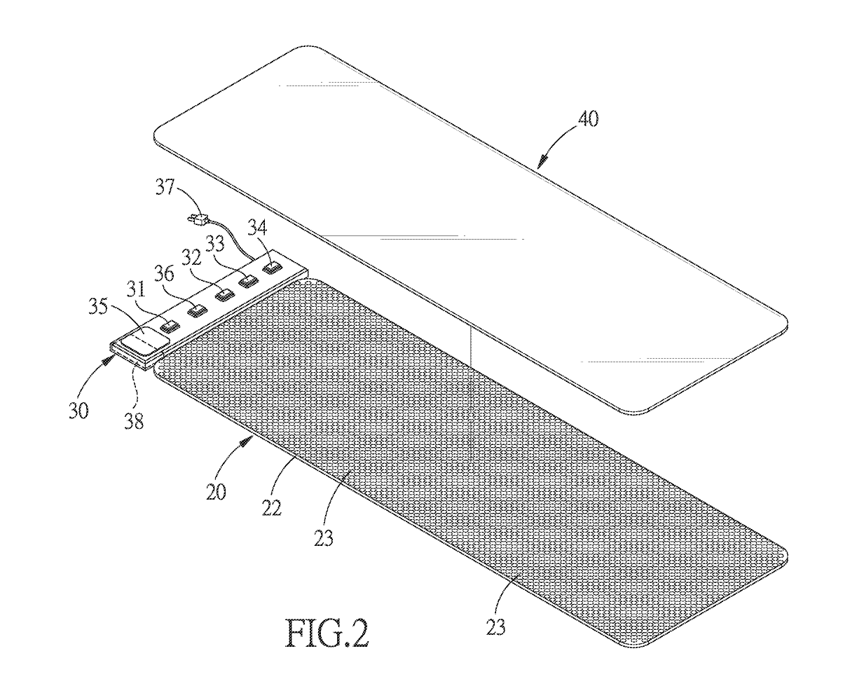

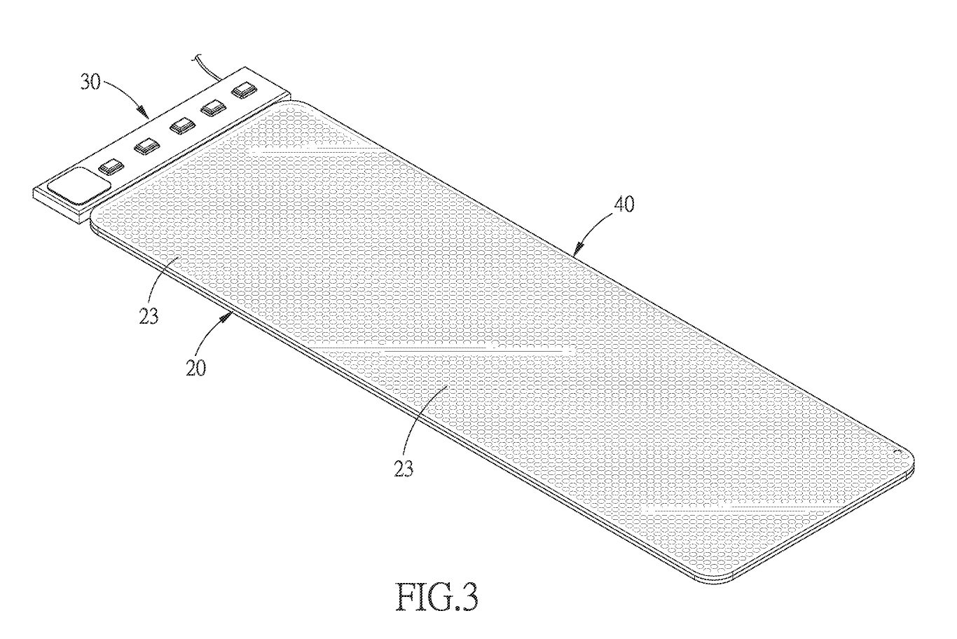

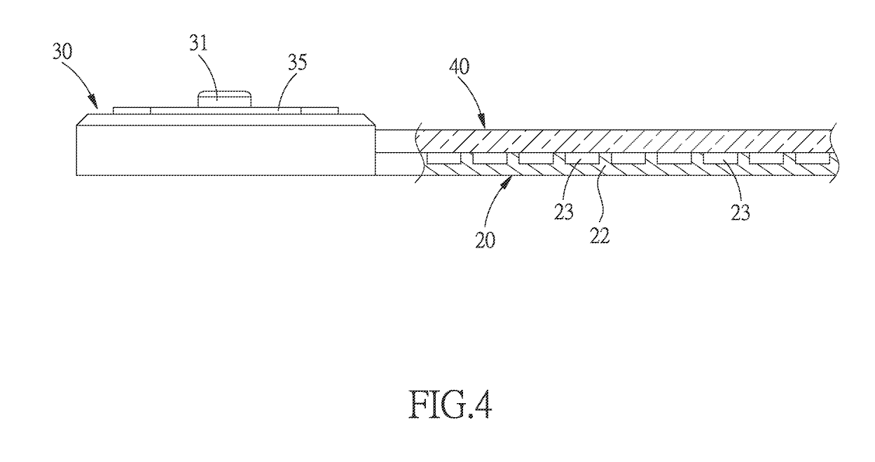

Referring to FIGS. 2-4, a floor-stretching exercise mat with movement guiding function in accordance with a first embodiment of the present invention comprises: a guiding mat 20, a control unit 30 and a transparent buffering mat 40.

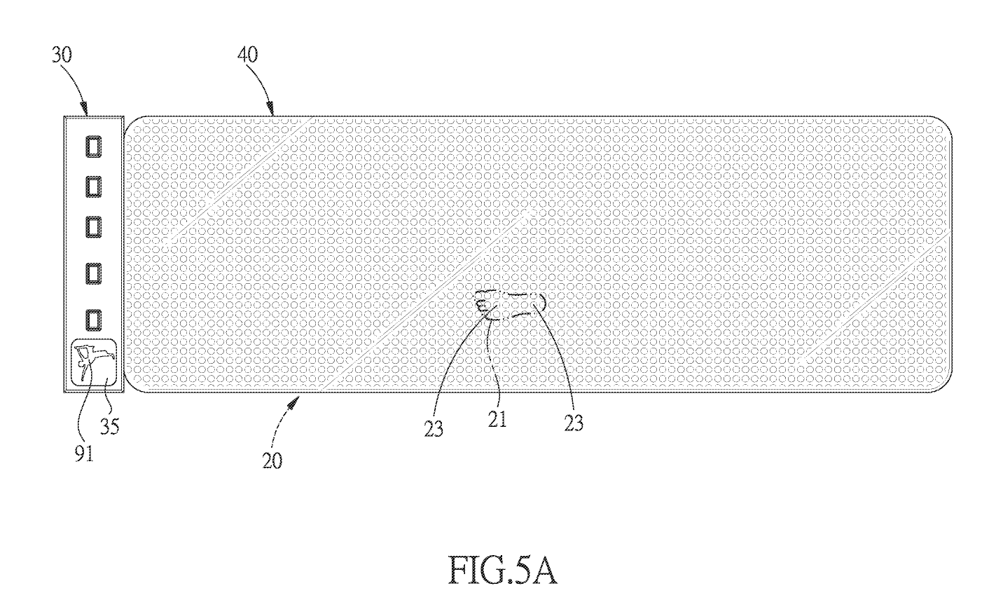

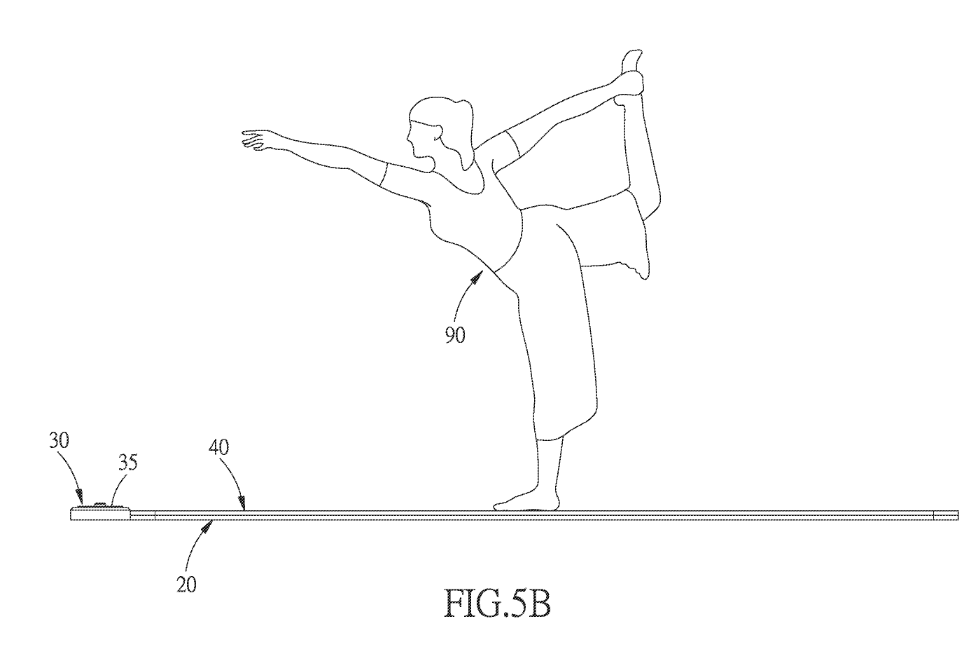

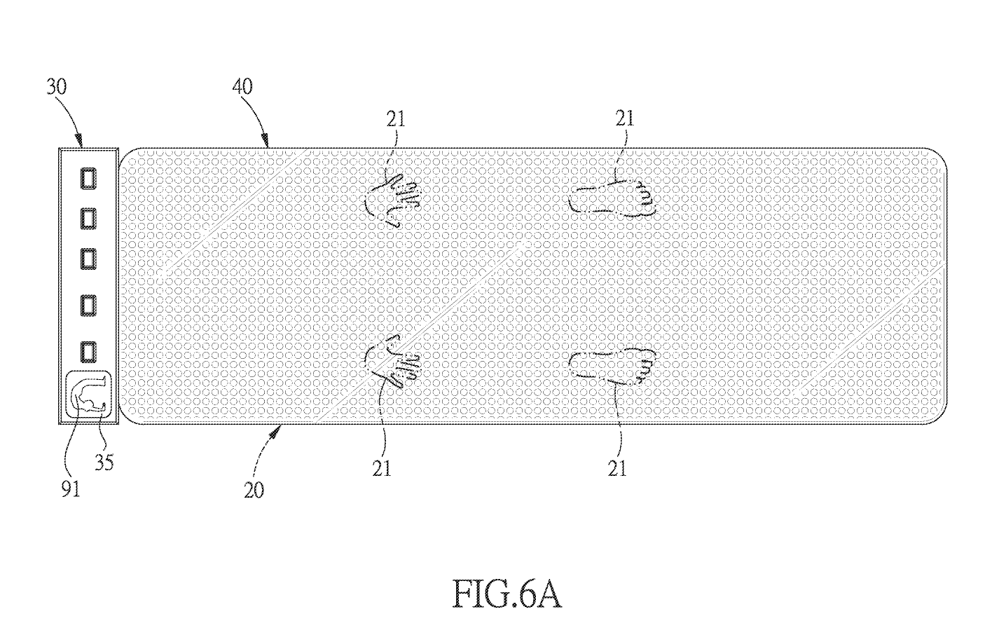

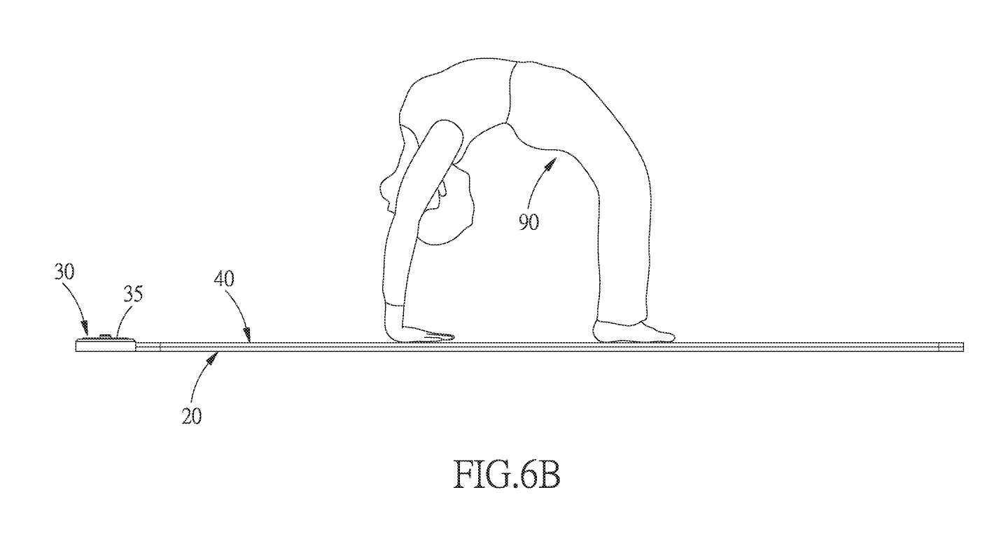

The guiding mat 20 includes at least one guiding portion 21 which is capable of continuously displaying predetermined shapes in different positions. In this embodiment, the guiding mat 20 includes a guiding board 22 and a plurality of light generating elements 23 disposed on the guiding board 22, and the light generating elements 23 constitute the guiding portion 21. As shown in FIG. 5A, the guiding mat 20 displays a single guiding portion 21, and as shown in FIG. 6A, the guiding mat 20 displays four different guiding portions 21.

The control unit 30 is electrically connected to the guiding mat 20 to control the shapes and positions of the guiding portions 21. In this embodiment, the control unit 30 includes a switch control button 31, an acoustic button 32, a mode button 33, a program button 34 and a display 35. The switch control button 31 controls On/Off of the guiding mat 20. The acoustic button 32 controls the playing and volume of music. The mode button 33 controls the display mode of the guiding portions 21, such as shapes, positions and frequency of the guiding portions 21. The program button 34 controls the difficulty levels of the exercise. The display 35 displays various statuses of the different buttons and is able to display a standard movement icon 91 (as shown in FIG. 5A) based on the displaying of the guiding portions 21. The control unit 30 further includes a wire or wireless receiver/transmitter 36, an external power source socket 37 and a built-in power source 38 for facilitating the control unit 30 to give instruction to relative components of the guiding mat 20 or receive information sent from the control unit 30 of other guiding mats 20.

The transparent buffering mat 40 is placed on the guiding mat 20 to enhance comfortableness when the user doing exercise while allowing the user to see the guiding portions 21.

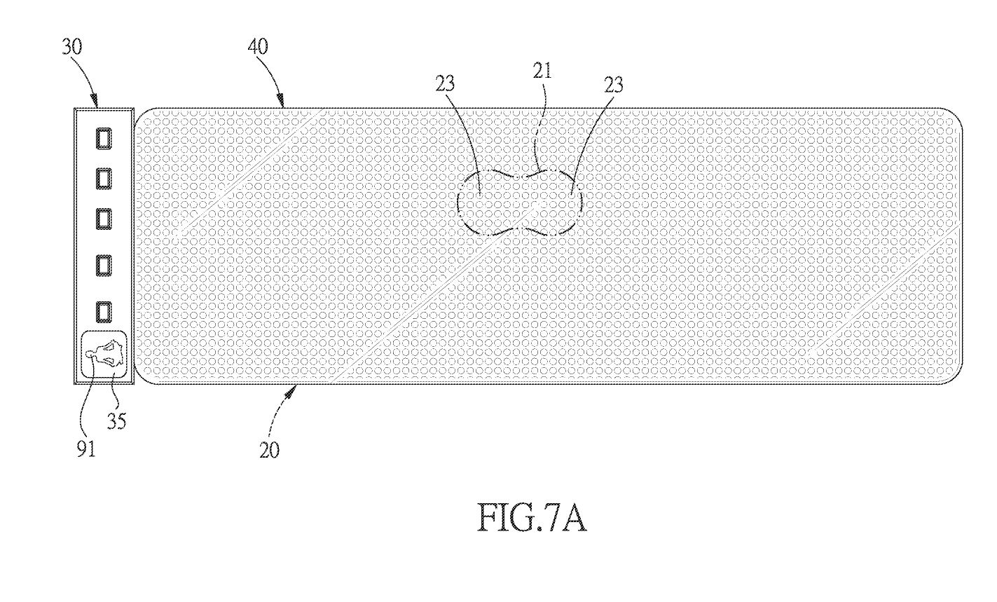

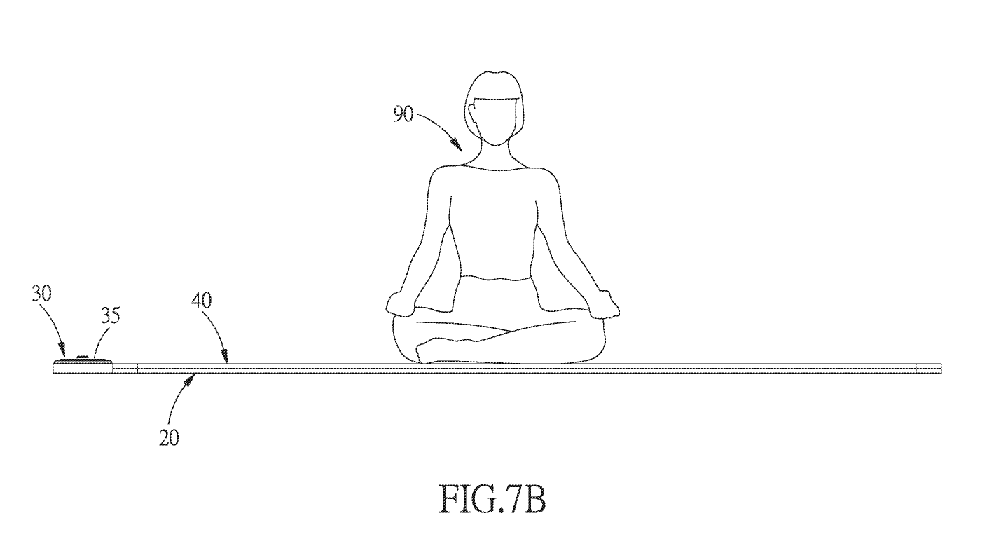

After the user presses the different buttons of the control unit 30 to choose the music to be played, the volume of the music, and the mode and difficulty level of the exercise, the guiding portions 21 with a predetermined shape will be displayed on the guiding mat 20, as shown in FIG. 5A, wherein the guiding portion 21 is in the form of a footprint, meanwhile, a corresponding standard movement icon 91 will be displayed on the display 35 to instruct the user 90 to do floor-stretching exercise, as shown in FIG. 5B. Then, with the automatic control of the control unit 30, the guiding mat 20 continuously displays the guiding portions 21 of predetermined shapes at predetermined positions, as shown in FIG. 6A, wherein the guiding portions 21 are two handprints and footprints. Meanwhile, the display 35 displays a standard movement icon 91 corresponding to the guiding portions 21, so as to instruct the user to practice the exercise, as shown in FIG. 6B. Similarly, as shown in FIGS. 7A and 7B, a guiding portion 21 in the shape of buttocks is displayed on the guiding mat 20, and the standard movement icon 91 corresponding to the guiding portion 21 is displayed on the display 35 instruct the user to practice exercise.

In addition to the buffering mat 40 which is capable of absorbing impact, the floor-stretching exercise mat of the present invention further provides a movement guiding function by using the guiding mat 20 and the control unit 30, which instructs the user 90 to perform standard movements under the guide of the guiding portions 21 without the presence of a teacher, so as to prevent the possibility that the user might get hurt by performing incorrect movements or postures.

In other words, the present invention provides a movement guiding method by using the floor-stretching exercise mat which comprises the guiding mat 20, the control unit 30 and the transparent buffering mat 40. The movement guiding method comprises the following steps:

operating the control unit 30 to make the guiding mat 20 continuously display the guiding portions 21 of predetermined shapes at predetermined positions; and

the user practice exercise based on the shapes and positions of the guiding portions 21.

It is to be noted that, after having been familiar with the movements of every mode of the exercise, the user 90 can control the control unit 30 to make the display 35 stop displaying the standard movement icon 91 corresponding to the guiding portions 21, providing an alternative choice for the user. Or, after having been familiar with the movements of a single exercise mode, the user 90 can control the control unit 30 to input the exercise mode and task response rate into a mobile phone via Bluetooth, then upload to Facebook or other social networks, showing off the difficulty level of the floor-stretching exercise and task response rate the user has achieved.

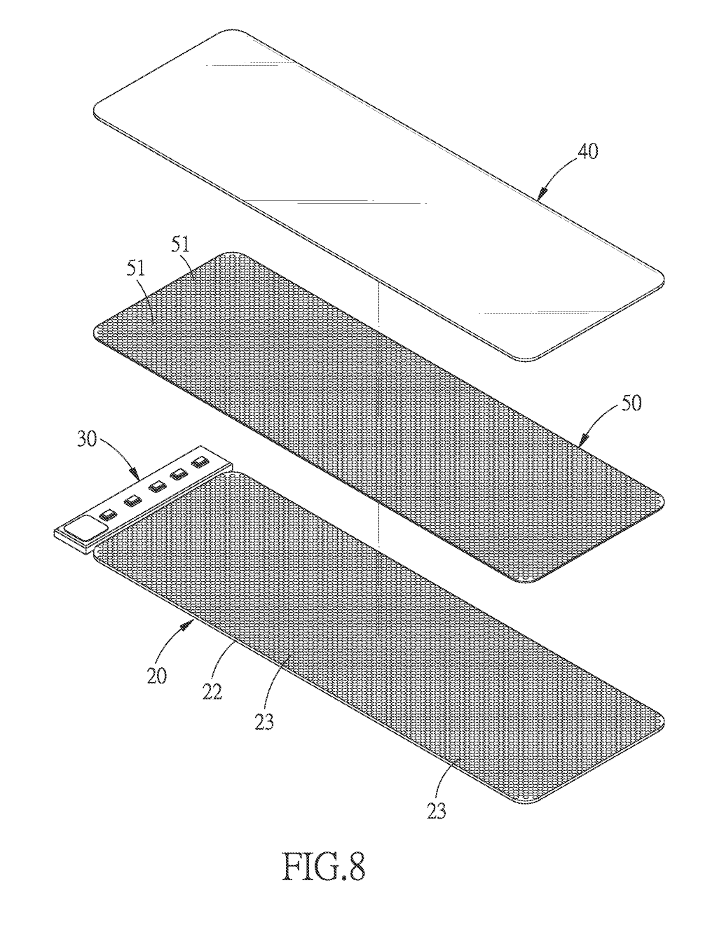

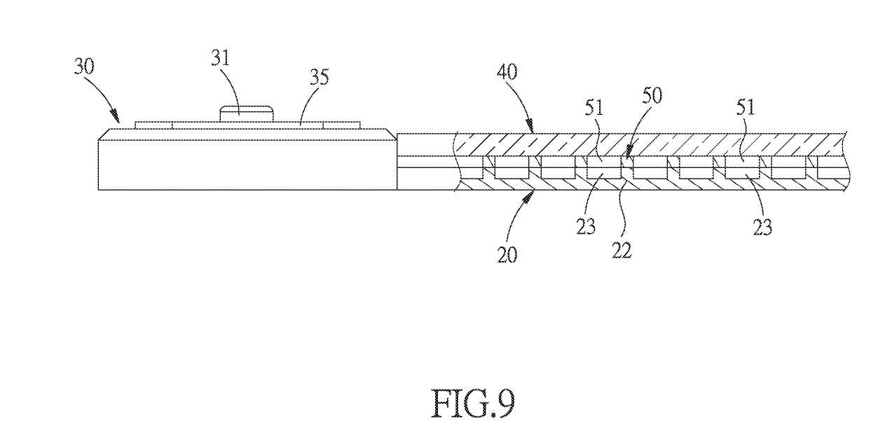

Referring then to FIGS. 8 and 9, a floor-stretching exercise mat with movement guiding function in accordance with a second embodiment of the present invention is similar to the first embodiment, except that: between the guiding mat 20 and the buffering mat 40 is further disposed a transparent sensing mat 50 which includes a sensor 51 aligned with the light generating elements 23 of the guiding mat 20.

When practicing exercise under the instruction of the guiding portions 21 of the guiding mat 20, the user will indirectly press the sensor 51, as a result, the sensor will send out a signal for another instruction, such as, second counting, the display of next guiding portion, etc, ensuring that the user can follow the instruction of the guiding portions displayed on the guiding mat 20 to perform the movement more close to the standard movement posture, and preventing the hurt caused by incorrect body position or posture. Furthermore, the signal sent from the sensor 51 can be transmitted to the control unit 30 to score the floor-stretching exercise performed by the user 90 by following the instruction of the guiding portions 21 of the guiding mat 20.

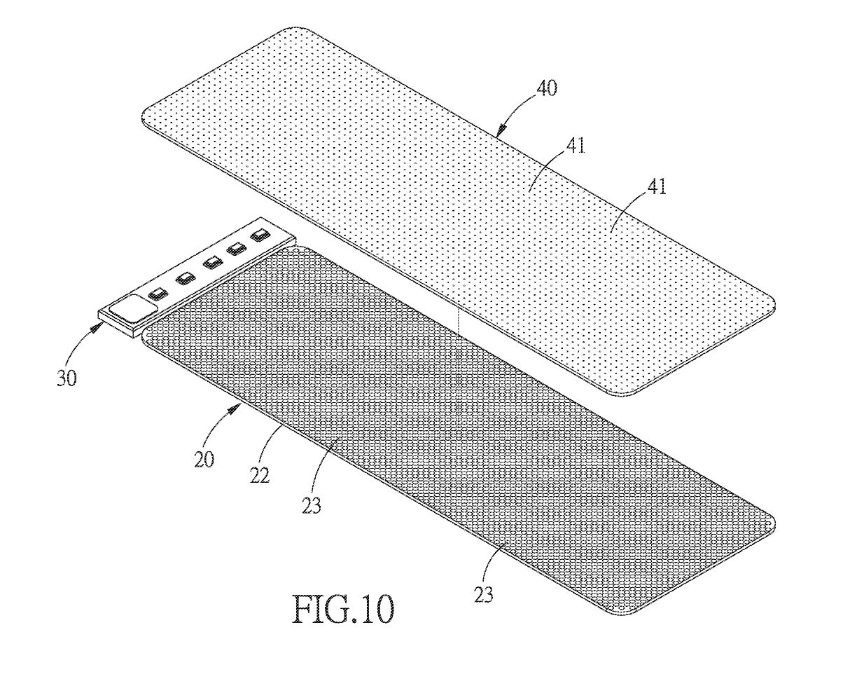

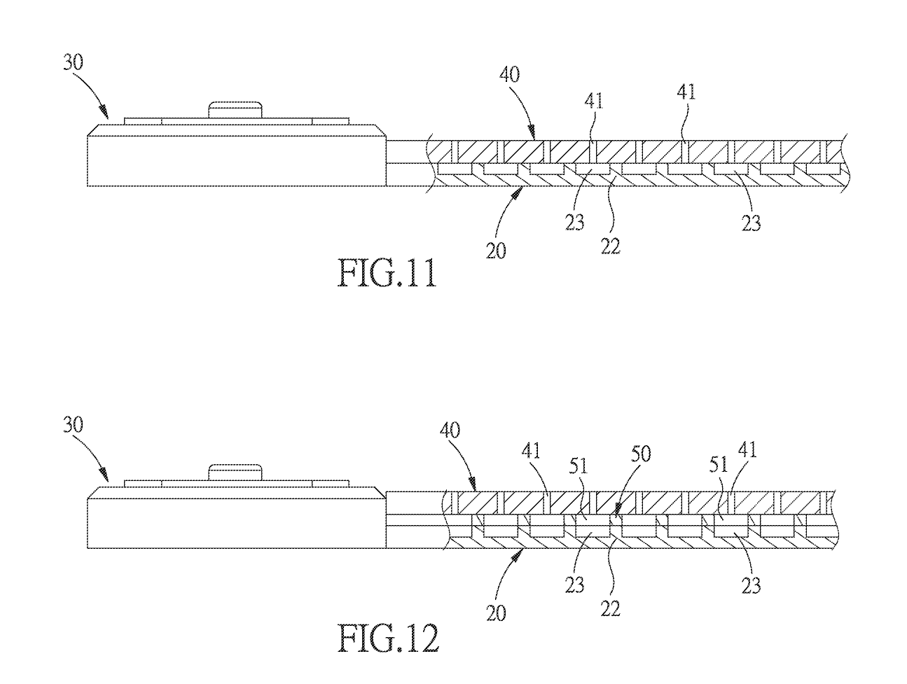

Referring then to FIGS. 10 and 11, a floor-stretching exercise mat with movement guiding function in accordance with a third embodiment of the present invention comprises: a guiding mat 20, a control unit 30 and a buffering mat 40.

The guiding mat 20 includes at least one guiding portion 21 which is capable of continuously displaying predetermined shapes in different positions. In this embodiment, the guiding mat 20 includes a guiding board 22 and a plurality of light generating elements 23 disposed on the guiding board 22, and the light generating elements 23 constitute the guiding portion 21.

The control unit 30 is electrically connected to the guiding mat 20 to control the shapes and positions of the guiding portions 21, and the control unit 30 of this embodiment is the same as the first embodiment, so further descriptions have been omitted.

The buffering mat 40 is placed on the guiding mat 20 and includes a plurality of light-passing apertures 41 aligned with the light generating elements 23.

When the guiding portions are displayed on the guiding mat 20, the light beam of the light generating elements 23 which constitute the guiding portions will be viewable through the light-passing apertures 41 to enable the user to see the positions and shapes of the guiding portions, ensuring that the user can follow the instruction of the guiding portions displayed on the guiding mat 20 to perform the movement more close to the standard movement posture, and preventing the hurt caused by incorrect body position or posture.

Referring then to FIG. 12, a floor-stretching exercise mat with movement guiding function in accordance with a fourth embodiment of the present invention is similar to the third embodiment, except that: between the guiding mat 20 and the buffering mat 40 is further disposed a transparent sensing mat 50 which includes a sensor 51 aligned with the light generating elements 23 of the guiding mat 20.

When practicing exercise under the instruction of the guiding portions of the guiding mat 20, the user will indirectly press the sensor 51, as a result, the sensor will send out a signal for another instruction, such as, second counting, the display of next guiding portion, etc, ensuring that the user can follow the instruction of the guiding portions displayed on the guiding mat 20 to perform the movement more close to the standard movement posture, and preventing the hurt caused by incorrect body position or posture.

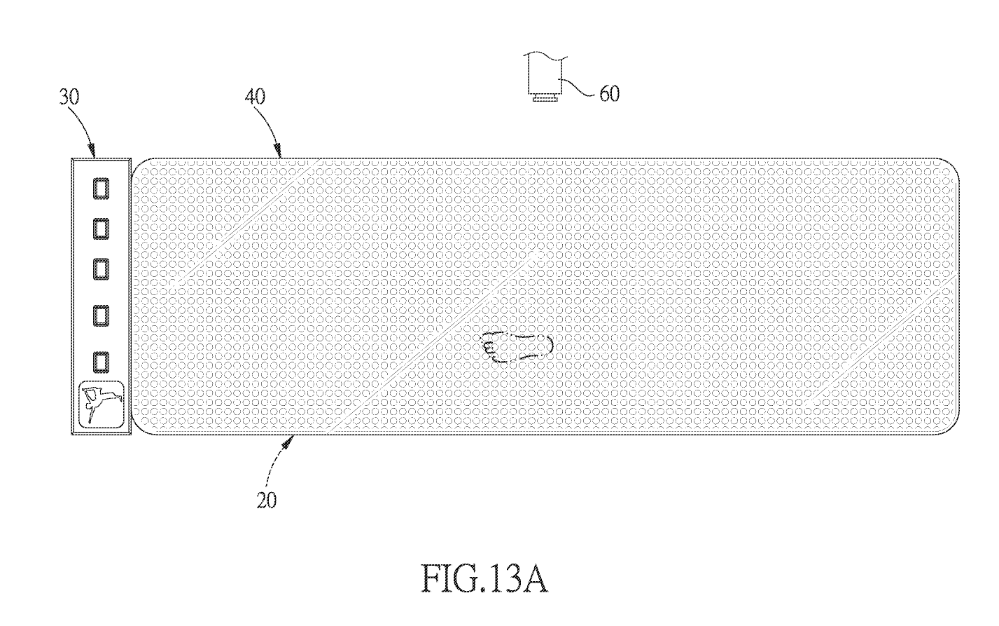

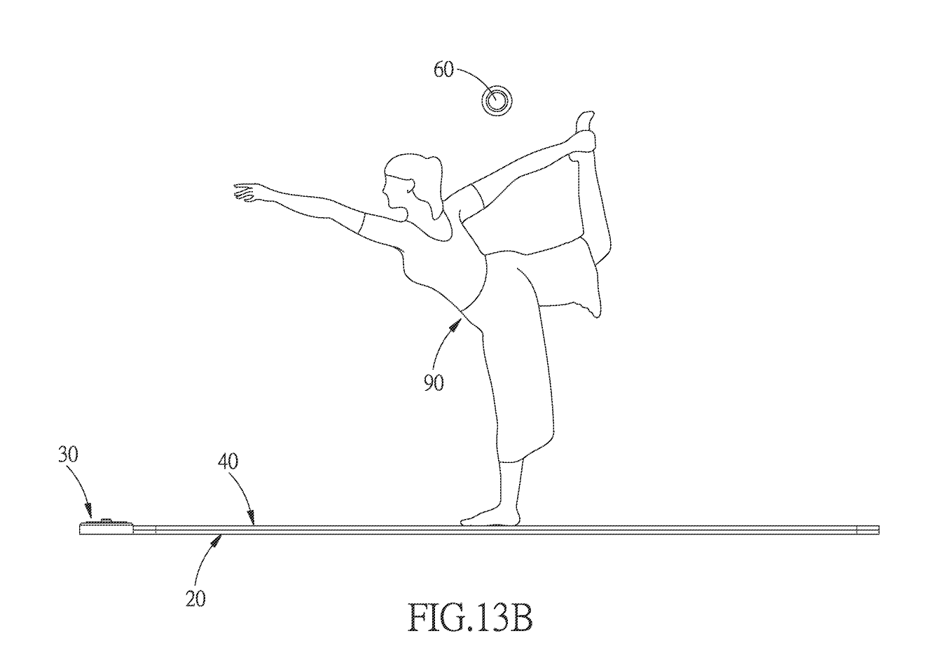

Referring then to FIGS. 13A and 13B, a floor-stretching exercise mat with movement guiding function in accordance with a fifth embodiment of the present invention is similar to the first embodiment, except that: it is further provided with a camera 60 capable of catching and uploading the body position/posture of the user 90 to the internet, so that the user 90 can practice floor-stretching exercise at home while having the teacher for guidance or doing exercise with the teacher from the internet. Similarly, the transparent buffering mat 40 can also be in the form of the fourth embodiment which is formed with light-passing apertures.

It is to be noted that the floor-stretching exercise mat with movement guiding function of the present invention can also be used in combination with on-line equipments to perform on-line teaching. Namely, it can put course notice on the internet, including course commencement time and date, trainees can apply for courses based on his/her degree and time schedule, and teacher can provide courses based on the demands of the trainees. After the commencement of the course, plural trainees are connected through internet, and the teacher can know whether the postures and movements of the trainees are correct by looking at the floor-stretching exercise mat with movement guiding function of the present invention, or the trainees and teacher can see each other's movements through the camera.

While we have shown and described various embodiments in accordance with the present invention, it is clear to those skilled in the art that further embodiments may be made without departing from the scope of the present invention.

1. A floor-stretching exercise mat with movement guiding function, comprising:
a guiding mat including guiding board and a plurality of light generating elements disposed on the guiding board and at least one guiding portion capable of continuously displaying predetermined shapes in different positions, the light generating elements constituting the guiding portion;
a control unit electrically connected to the guiding mat to control the shapes and positions of the guiding portions; and
a transparent buffering mat placed on the guiding mat.

2. (canceled)

3. The floor-stretching exercise mat with movement guiding function as claimed in claim 1, wherein the control unit includes a switch control button, an acoustic button, a mode button, a program button, a display, and a wire or wireless receiver/transmitter for receiving or transmitting signal.

4. The floor-stretching exercise mat with movement guiding function as claimed in claim 3, wherein the display displays a standard movement icon corresponding to the guiding portions.

5. (canceled)

6. (canceled)

7. (canceled)

8. (canceled)

9. (canceled)

10. (canceled)

11. (canceled)
